(19) United States
(12) Patent Application Publication
(10) Pub. No.: US 2026/0204443 A1
(43) Pub. Date: Jul. 16, 2026

(54) TEMPERATURE ACTIVATED PASSIVE SHUTDOWN DEVICE FOR A NUCLEAR REACTOR

(71) Applicant: MOLTEX ENERGY LTD, Stratford-upon-Avon (GB)

(72) Inventor: Luke GODFREY, Stratford-upon-Avon (GB)

(73) Assignee: MOLTEX ENERGY LTD, Stratford-upon-Avon (GB)

(21) Appl. No.: 19/137,708

(22) PCT Filed: Sep. 19, 2023
(86) PCT No.: PCT/EP2023/075838

§ 371 Date: Jun. 11, 2025

(30) Foreign Application Priority Data
Dec. 12, 2022 (GB) 2218641.5

(51) Int. Cl. G21C 9/033; G21C 3/22; G21C 3/24; G21C 3/44; G21C 7/22; G21C 7/26; G21C 7/28; G21C 7/30

(52) U.S. Cl. CPC G21C 9/033; G21C 3/22; G21C 3/24; G21C 3/44; G21C 7/22; G21C 7/26; G21C 7/28; G21C 7/30

(57) ABSTRACT

A nuclear fission reactor comprising a passive thermal shut-down device, and a reactor core containing fissile fuel. The passive thermal shutdown device comprises a reservoir and a Pythagorean syphon. The reservoir is in thermal communication with the reactor core, and containing a neutron poison material which has a free surface. The Pythagorean syphon has an inlet within the reservoir, an outlet in fluid communication with the reactor core. When the neutron poison material overtops the syphon due to thermal expansion, the neutron poison material flows through the Pythagorean syphon and into the reactor core. Also provided are nuclear fission reactors having passive thermal shutdown devices using a Pythagorean syphon to control the flow of fissile fuel, neutron moderators, or neutron reflectors.

### FIELD OF THE INVENTION

The present invention relates to nuclear fission reactors. In particular the present invention relates to passively activated shutdown systems for a nuclear fission reactor, and reactor designs incorporating such.

### BACKGROUND

Nuclear reactors utilise a variety of means to control reactivity. A key criteria for such systems is reliability of operation-shutdown systems need to have very low probabilities of failure per activation. The likelihood that a shutdown system fails to operate is often decreased by using independent banks of shutdown mechanisms, so a failure in one bank does not prevent the bank in the system operating.

A further improvement seen in many reactors is the addition of diverse means of shutdown—different mechanisms are used together (such as control rods and soluble poison) such that a common mode failure can only remove one means of shutdown.

Traditionally, means of shutdown in nuclear reactors have been “active”—that is, they require some type of active controlling signal to function. This signal could take the form of a man with an axe, or cutting power to an electromagnet, but all require an action (positive or negative) to operate a shutdown mechanism (usually a control rod). The failure of this control signal is a possibility in all active shutdown systems, which reduces their reliability.

There also exist “passive” shutdown systems, which operate directly from key reactor parameters without any external signal. These may use the reactor temperature, coolant pressure, coolant flow rate, or other parameters to operate with no external signals.

For completeness, there also exist “inherent” shutdown mechanisms, which happen inherently, with no operation of any kind required. An example would be a fuel negative temperature coefficient.

The reliability of a system is also affected by its complexity-a system with few moving parts is (in general) more reliable than one with many moving parts. This is because each part is a potential point of failure. Thus, an ideal shutdown system would have as few moving parts as possibly.

Reactor control rods often have very few moving parts, and sometimes only one-the rod itself. These systems can use gravity to drive the rod into the core, eliminating the possibility of a drive mechanism failure. However, there still exists the possibility of the rod itself jamming in its sleeve, through thermal expansion of the rod or sleeve material, irradiation swelling, creep, distortion or other damage caused by external forces.

Liquid parts and mechanisms are more tolerant to mechanical damage than solid parts and mechanisms (such as control rods). In order to operate, solid parts and mechanisms need to maintain linearity, concentricity, clearances, and key part lengths, and need to remain free of obstructing debris. By contrast, liquid parts only require that the liquid not change key properties (via changes in temperature, irradiation, and chemical reactions), that volumes are preserved after damage, and that flow paths are not completely closed. Previous examples of passively activated shutdown systems have always included a mechanical component. This includes many proposed configurations where a pressurised neutron absorbing material is released into a reactor through the passive or active actuation of a valve, such as those disclosed in U.S. Pat. Nos. 3,900,365A, 5,145,638A, CN107507652A, U.S. Pat. No. 5,130,078A, EP2689426B1, U.S. Pat. No. 7,873,136B2, WO2019/200468A1, and EP0512761A1.

Another method of operation previously proposed using mechanical operation is using bursting disks to activate a mechanical shutdown mechanism, such as this disclosed in EP0221298A1, which uses a temperature-operated bursting disk to actuate a pre-pressurised piston, or US2018/0174693A1, where a reservoir of molten metal with a high vapor pressure activates a bursting disk at a certain temperature, expelling a second molten metal which acts as a neutron absorber in the reactor.

Magnetism can be used to reduce the number of moving parts—U.S. Pat. No. 3,976,540A describes a control rod held out of the core by a permanent magnet thermally coupled to the reactor. Upon heating to its curie point, the magnet stops working and the control rod falls into the core.

Systems with fluid poisons can also use pumps to control the injection. A system of pump-maintained “density locks” are described in WO1995/029486A1 to hold poisoned coolant out of the core of a reactor. WO2021/191407A1 describes a similar device.

Thermal expansion has been suggested before as a driver for a mechanism, but for shutdown mechanisms this has always been coupled to a mechanical system, such as in U.S. Pat. No. 4,204,909A, where an expanding sensing fluid drives a bellows-connected push-rod, releasing a control rod into the core.

### SUMMARY

According to a first aspect, there is provided a nuclear fission reactor comprising a passive thermal shutdown device, and a reactor core containing fissile fuel. The passive thermal shutdown device comprises a reservoir and a Pythagorean syphon. The reservoir is in thermal communication with the reactor core, and containing a neutron poison material which has a free surface. The Pythagorean syphon has an inlet within the reservoir, an outlet in fluid communication with the reactor core. When the neutron poison material overtops the syphon due to thermal expansion, the neutron poison material flows through the Pythagorean syphon and into the reactor core.

According to a second aspect, there is provided a nuclear fission reactor. The nuclear fission reactor comprises a passive thermal shutdown device, a criticality safe dump tank, and a reactor core containing a fully or partially liquid fissile fuel, which has a free surface. The passive thermal shutdown device comprises a Pythagorean syphon having inlet within the liquid fissile fuel, an outlet in fluid communication with the criticality safe dump tank. When the fissile fuel overtops the Pythagorean syphon due to thermal expansion, the fissile fuel flows through the Pythagorean syphon and into the criticality safe dump tank.

According to a third aspect, there is provided a nuclear fission reactor. The nuclear fission reactor comprises a passive thermal shutdown device, and a reactor core containing fissile fuel. The passive thermal shutdown device comprises a reservoir and a Pythagorean syphon. The reservoir is in thermal and neutronic communication with the reactor core, and contains a liquid neutron moderator or reflector which has a free surface. The Pythagorean syphon has an inlet within the reservoir, an outlet in fluid communication with a drain which leads to a location that is not in neutronic communication with the reactor core. When the neutron moderator or reflector overtops the syphon due to thermal expansion, the neutron moderator or reflector flows through the Pythagorean syphon and into the drain.

With no moving solid parts, there is no possibility of the activation failing due to parts jamming, as the liquid parts cannot become distorted or physically damaged by heat, pressure or irradiation. An excess of heat would simply activate the syphon, shutting down the reactor-this would occur before the working fluid begins to boil.

In the event that the solid parts of the reservoir or syphon become damaged in the first aspect, the liquid neutron poison will simply leak into the reactor and cause a shutdown, exactly as if it had been operated by thermal expansion.

In the event that the solid parts of the syphon become damaged in the second aspect, the liquid fissile fuel will leak into the criticality-safe dump tanks, exactly as if it had been operated by thermal expansion.

In the event that the solid parts of the syphon become damaged in the third aspect, the liquid moderator or reflector will leak away from the critical region, exactly as if it had been operated by thermal expansion.

### BRIEF DESCRIPTION OF THE DRAWINGS

FIG. 1 shows a Pythagorean syphon,

FIG. 2 shows a basic configuration of the poison reservoir,

FIG. 3 shows the order of operation of the poison reservoir,

FIG. 4 shows a nuclear reactor with a flow of coolant, and a poison reservoir designed to poison the core directly without mixing with the coolant,

FIG. 5 shows a nuclear reactor core with a flow of coolant, with a poison reservoir designed to poison the core coolant loop,

FIG. 6 shows a configuration of the poison reservoir with a separate sensing bulb,

FIG. 7 shows a reactor using a liquid fissile fuel, with a syphon through the core arranged to remove the fuel in the event of an overtemperature fault,

FIG. 8 shows a reactor using a liquid fissile fuel, with a syphon outside of the core arranged to remove the fuel in the event of an overtemperature fault,

FIG. 9 shows a basic configuration of the moderator/reflector reservoir,

FIG. 10 shows a configuration of a poison reservoir using a bubbler airlock to prevent the poison evaporating away,

FIG. 11 shows a configuration of a poison reservoir using a gas escape line to prevent gas in the syphon causing a backpressure, and

FIG. 12 shows a configuration of an activated poison reservoir using a gas escape line to prevent gas in the syphon causing a backpressure.

### DETAILED DESCRIPTION

A device is proposed below to passively add neutron absorbing material, or remove fissile or moderating material, from a reactor core in the event that the reactor temperature exceeds some limit. It can achieve this with liquid neutron poison, liquid fissile fuel, or liquid neutron moderating material using the same principal found in a Pythagorean cup—a syphon that irreversibly starts once the level of the liquid rises above a certain level.

A neutron poison, or neutron absorbing material is defined as a material which contains neutron absorbing isotopes—i.e. isotopes with a high neutron capture cross-section. A neutron absorbing isotope will typically have a capture cross-section above 10 barns at thermal energies (0.001 to 100 eV), or above 0.01 barns at fast energies (10 keV to 10 MeV). A neutron absorbing element is an element having a neutron absorbing isotope. Neutron absorbing elements include: boron, dysprosium, europium, gadolinium, hafnium, iodine, xenon, samarium, caesium, cadmium, erbium.

A burnable poison material is a neutron poison which significantly reduces in absorption cross-section after absorbing a neutron. This includes materials containing all previously listed neutron absorbing elements except hafnium, which absorbs several neutrons before significantly reducing in absorption cross-section.

A neutron moderating material is defined as a material which contains neutron moderating isotopes, i.e. isotopes with a high moderating ratio. The moderating ratio is the ratio of the macroscopic slowing down power of a material to the neutron absorption cross section. The macroscopic slowing down power is the product of the average logarithmic energy decrement of the material and the macroscopic cross section for scattering in that material. The logarithmic energy decrement of a material is the average change in the logarithm of neutron energy when a neutron undergoes elastic scattering from a nucleus of that material.

A typical neutron moderating isotope will have a moderating ratio of greater than 1.

A neutron reflecting material is defined as a material which contains neutron reflecting isotopes, i.e. isotopes with a high elastic neutron scattering cross-section and a low neutron absorption cross-section.

A typical neutron reflecting isotope will have a ratio of elastic neutron scattering to the neutron absorption cross-section of greater than 1.

A fissile material, or fissile fuel is defined as a material capable of sustaining a nuclear fission chain reaction. This means material containing one or more of: U-235, U-233, Pu239, Pu-240, Pu-241, Pa-240, Np-235, and Am-242.

For two regions to be in “neutronic communication” means that neutrons can travel between the two regions without significant attenuation—i.e. there is no intervening neutron shielding between the regions. “Thermal communication” means that heat energy can travel between the two regions (whether by conduction, convection, or radiation), such that the temperature of one region significantly influences the temperature of the other.

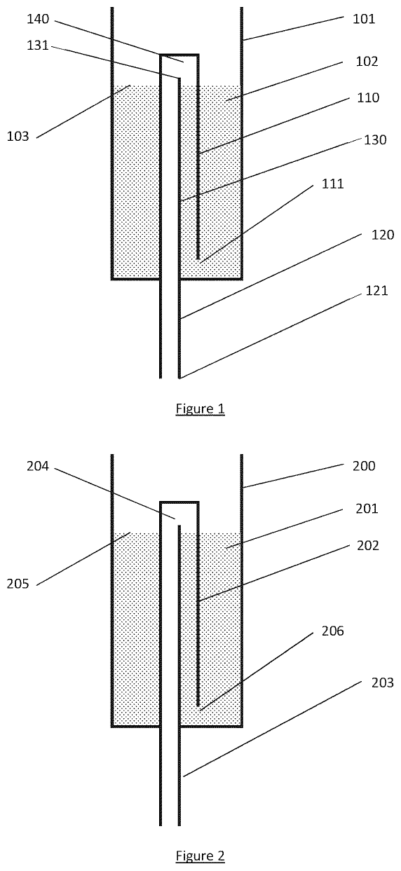

FIG. 1 shows a Pythagorean cup syphon. The syphon comprises an inlet chamber 110 having an inlet 111 connected to a reservoir 101, an outlet chamber 120 comprising an outlet 121 located lower than the inlet, and a structure 130 therebetween. The inlet and outlet chambers are separated by the structure, and connected by a passage 140 located above the top edge 131 of the structure. In the initial state, the inlet chamber 110 contains a liquid 102 having its surface 103 at a level below the top edge 131, and the outlet chamber 120 and passage 140 do not contain a liquid. When the level of the liquid 101 increases such that it overtops the syphon, i.e. rises above the top edge 131 and fills the passage 140, the liquid begins to flow into the outlet chamber 120 via the passage 140 and a syphon action begins. The syphon action will drain liquid from the reservoir 101 through the inlet, passage, and outlet, until the liquid in the reservoir is level with the outlet.

The advantage of this mechanism is that it used no moving parts other than the liquid to be drained. This means the mechanism can, to a degree, still operate when solid parts are bent, distorted, weakened, or otherwise damaged. Failure of the solid part of the syphon is safe, as it simply leads to premature activation and shutdown, rather than preventing the system from operating.

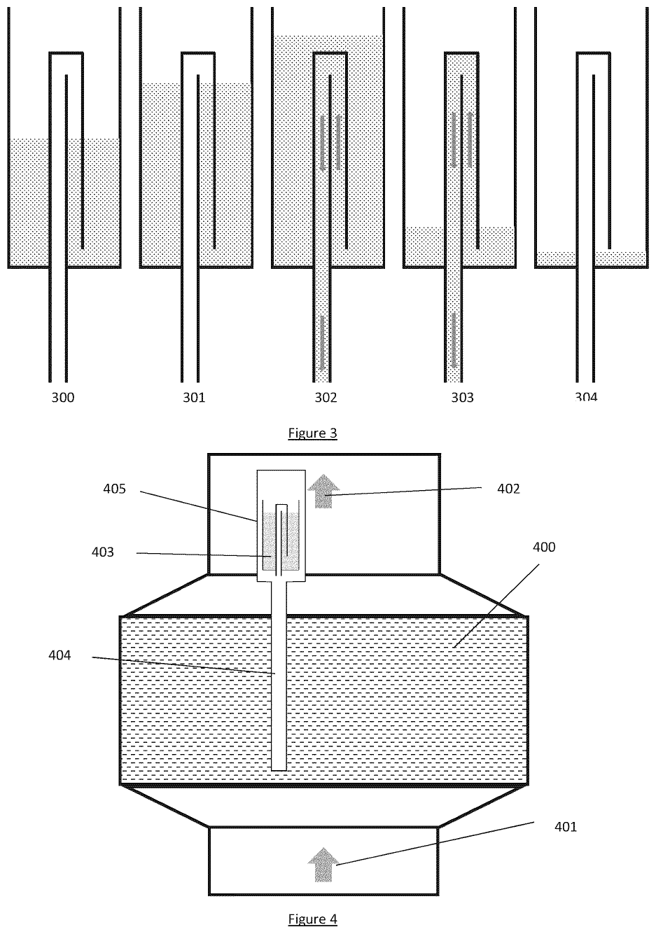

FIG. 2 shows passive thermal shutdown device. A reservoir container 200, contains a liquid neutron poison 201. This poison 201 will thermally expand as the temperature increases, raising the surface level 205. A syphon 202 is fixed within the reservoir container 200, in fluid communication to the poison 201. The reservoir container 200 is configured such that when the poison 201 reaches a predefined trigger temperature, the poison level 205 rises above the top of the syphon 204, filling the whole syphon 202, and draining the poison inventory 201 through the syphon pipe 203, until the poison level 205 falls below the syphon bottom 206.

There are a number of features that could be added to improve the performance of the passive reactor control device. If the poison reservoir is too large to place directly into the coolant stream or too heavy to respond to changes in temperature quickly, a separate sensing bulb can be placed in the stream, connected to the reservoir by means of a thin capillary tube, both filled with liquid poison. The thermal expansion of the liquid poison inside the sensing bulb triggers the syphon, rather than bulk expansion of the entire reservoir. This principal also works for liquid moderator filled reservoirs.

Another potential feature is a reduction in the surface area in the reservoir near the height of the syphon top. This feature ensures that the liquid expands quickly into the syphon once the trigger temperature is reached.

If the liquid poison or moderator is volatile, the reservoir container may be sealed, with a large gas volume to ensure that the emptying liquid poison or moderator does not cause a large negative pressure to be developed as it leaves the reservoir container. Negative pressures in the reservoir container are undesirable as they could prevent the full inventory being emptied.

A second potential option to mitigate poison or moderator volatility is a shallow bubbler airlock, that would prevent vapours leaving the reservoir, but still allow gas to be drawn into the reservoir container during activation. The bubbler airlock liquid would ideally have a low vapour pressure, be denser than the poison or moderator, and be immiscible with the poison or moderator. This combination of properties would allow vapours to be re-condensed onto the near surface of the bubbler airlock, and drain back into the reservoir.

FIG. 3 shows the passive thermal shutdown device of FIG. 2 through several states of activation. When the reactor coolant outlet temperature is low 300, the level of poison within the reservoir is low. As the coolant outlet temperature rises, the poison thermally expands 301, until it rises above the syphon 302, and starts to drain 303. This process continues until the reservoir is empty 304.

FIG. 4 shows a nuclear reactor with a core 400, a cold coolant inlet 401, and a hot coolant outlet 402. The passive thermal shutdown device 403 (identical to that in FIG. 2) is placed in a sealed container 405 inside the flow of the hot coolant outlet 402. In this configuration the sealed container 405 allows gas displaced by the emptying passive thermal shutdown device 403 to return to the reservoir, stopping a negative pressure forming. Upon activation, the passive thermal shutdown device injects the liquid poison into a reserved channel 404 that extends into the core, bringing the reactor subcritical. Note that the coolant could be any fluid substance, including a liquid or gaseous fissile fuel.

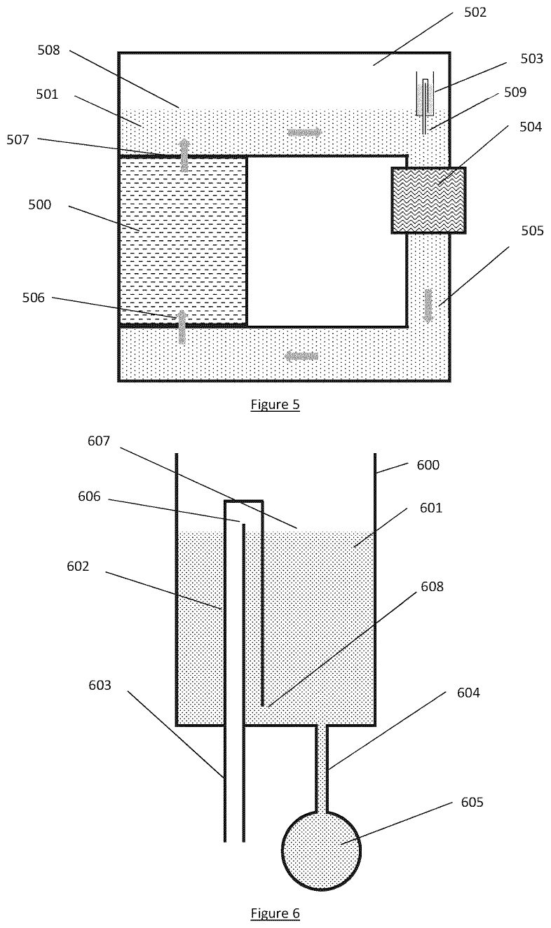

FIG. 5 shows a nuclear reactor with a core 500, and a liquid coolant flow 501 that flows around a circuit 505, passing through the core 500 via an inlet 506 and an outlet 507. The coolant flow may either be driven using a pump (not shown), or by natural convection. A heat exchanger 504 may exist somewhere within the circuit. The passive thermal shutdown device 503 (identical to that in FIG. 2) is placed in thermal contact with the flow of hot coolant 507 exiting the core 500. The reservoir of the passive thermal shutdown device 503 is open to a gas space 502. This gas space 502 may or may not be connected to the reactor coolant (in FIG. 5 it is). Upon activation, the poison is injected through the syphon pipe 509 into the flow of coolant in the circuit 505, with which it is miscible. This injection may take place near the passive thermal shutdown device 503 (as shown), or in another part of the circuit, such as at the core inlet 506. This poisoned coolant will then circulate through the coolant circuit 505 and core 500, bringing the reactor subcritical. Note that the coolant could be any suitable liquid, including a liquid fissile fuel or moderator.

FIG. 6 shows an alternative passive thermal shutdown device. A reservoir container 600 contains a liquid neutron poison 601. This poison 601 will thermally expand as the temperature increases, raising the liquid level 607. Attached to the reservoir 601 is a stem 604 connecting a sensing bulb 605, both filled with the same poison 601. The bulb 605 is configured such that when the temperature of the poison 601 within it reaches a predefined trigger temperature, the poison level 607 within the reservoir 600 rises above the top of the syphon 606, filling the whole syphon 602, and draining the poison inventory 601 through the syphon pipe 603, until the poison level 607 falls below the syphon bottom 608.

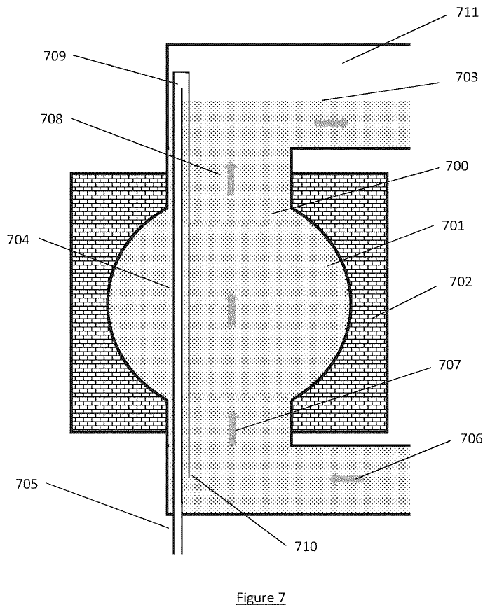

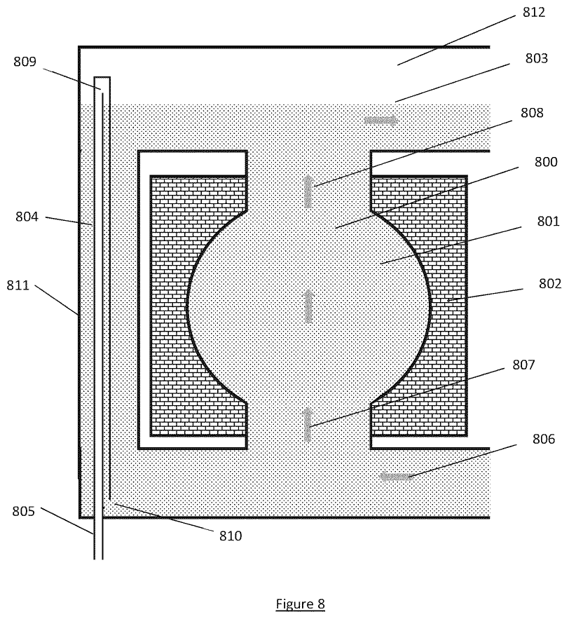

FIG. 7 shows a further alternative passive thermal shutdown device. A nuclear reactor core 700 is filled with liquid fissile fuel 701, bounded by some core boundary 702. The liquid fissile fuel 701 flows through the core 700 from an inlet 707 to an outlet 708. The direction of flow is shown by the arrows 706. This flow may be due to a pump (not drawn) or natural convection. The liquid fissile fuel has a free surface 703, above which is a gas space 711. Partially immersed within the fuel volume is the syphon 704. If the liquid fissile fuel 701 increases in temperature, the thermal expansion will cause the surface of the fuel 703 to rise above the syphon top 709, filling the whole syphon 704, and draining some or all of the fuel 701 from the core 700 through the syphon pipe 705 into criticality-safe dump tanks (not drawn), until the fuel level 703 falls below the syphon bottom 710. The criticality safe dump tanks are configured such that, when filled with any amount of the liquid fissile fuel, the liquid fissile fuel will be subcritical. This may be done e.g. by baffles to reduce the density of the fuel, the shape of the tanks, the inclusion of neutron absorbing materials within the tanks, or other suitable means,

FIG. 8 shows a variant of the alternative presented in FIG. 7. A nuclear reactor core 800 is filled with liquid fissile fuel 801, bounded by some core boundary 802. The liquid fissile fuel 801 flows through the core 800 from an inlet 807 to an outlet 808. The direction of flow is shown by the arrows 806. This flow may be due to a pump (not drawn) or natural convection. The liquid fissile fuel has a free surface 803, above which is a gas space 812. Partially immersed within the fuel volume is the syphon 804. In this configuration, the syphon 804 passes through a wet well 811 instead of the core 800. This arrangement protects the syphon 804 from irradiation damage. If the liquid fissile fuel 801 increases in temperature, the thermal expansion will cause the surface of the fuel 803 to rise above the syphon top 809, filling the whole syphon 804, and draining some or all of the fuel 801 from the core 800 through the syphon pipe 805 into criticality-safe tanks (not drawn), until the fuel level 803 falls below the syphon bottom 810.

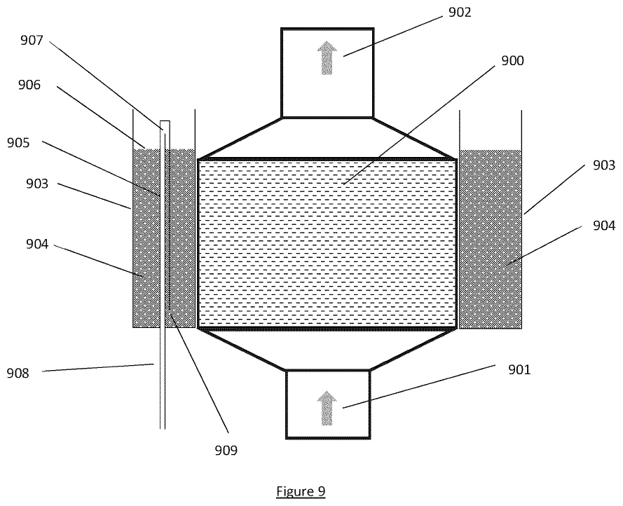

FIG. 9 shows yet further alternative passive thermal shutdown device. A nuclear reactor core 900 has a coolant inlet 901 and outlet 902. In thermal and neutronic communication with the core 900 is a reservoir container 903, filled with a moderating liquid 904. A syphon 905 is fixed within the reservoir container 903, in fluid communication to the moderator fluid 904. The reservoir container 903 is configured such that when the moderator fluid 904 reaches a predefined trigger temperature, the surface level 906 rises above the top of the syphon 907, filling the whole syphon 905, and draining the moderator inventory 904 through the syphon pipe 908, until the moderator level 906 falls below the syphon bottom 909.

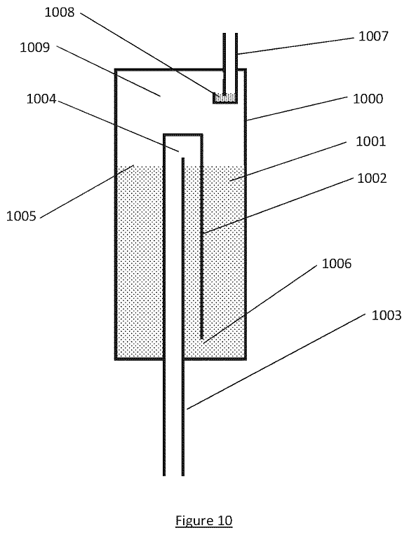

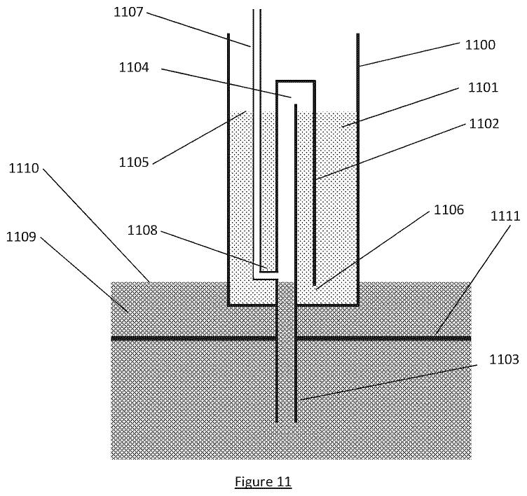

FIG. 10 shows a variant passive thermal shutdown device with a bubbler airlock for a connection to a gas space that may be applied to any of the examples above. A reservoir container 1000, contains a liquid neutron poison 1001, and a gas space 1009. This poison 1001 will thermally expand as the temperature increases, raising the surface level 1005. This also pushes displaced gas from the gas space 1009 through the bubbler airlock 1007, which is filled with a shallow pool of low volatility liquid 1008. A syphon 1002 is fixed within the reservoir container 1000, in fluid communication to the poison 1001. The reservoir container 1000 is configured such that when the poison 1001 reaches a predefined trigger temperature, the poison level 1005 rises above the top of the syphon 1004, filling the whole syphon 1002, and draining the poison inventory 1001 through the syphon pipe 1003, until the poison level 1005 falls below the syphon bottom 1006. The bubbler airlock 1007 allows gas to flow freely into the gas space 1009 through the low volatility liquid 1008.

A bubbler airlock consists of a liquid pool and a divider that separates two volumes of gas. Gas is unable to freely flow from one volume to the other unless the pressure difference is high enough to push the liquid aside, allowing bubbles to pass underneath the divider. This pressure can be changed by changing the depth of the liquid pool. Any volatile species that comes into contact with the liquid will not be able to pass provided the vapour pressure is lower than the pressure required to push the liquid aside. This will leave any poison or moderator vapour to re-condense on the available surfaces and drain back into the reservoir, preventing mass loss. In this case the first volume of gas is the gas space 1009, and the second volume of gas is the gas space outside of the passive thermal shutdown device, with the container 1000 and the body of the bubbler airlock 1007 forming the divider between the two spaces.

FIG. 11 shows a variant passive thermal shutdown device with a gas escape line that may be applied to any of the examples above. A reservoir container 1100 contains a liquid neutron poison 1101. This poison 1101 will thermally expand as the temperature increases, raising the surface level 1105. A syphon 1102 is fixed within the reservoir container 1100, in fluid communication to the poison 1101. The reservoir 1100 is partially submerged in a coolant fluid 1109, with a free surface 1110, and submerged geometry 1111 that is to be bypassed (such as a heat exchanger or pump). The syphon 1102 has connected to it a gas escape line 1107, which rises above the top of the syphon 1104. The gas escape line's connection point 1108 is located above the free surface of the coolant fluid 1110. The reservoir container 1100 is configured such that when the poison 1101 reaches a predefined trigger temperature, the poison level 1105 rises above the top of the syphon 1104, filling the whole syphon 1102 and the gas line 1107, and draining the poison inventory 1101 through the syphon pipe 1103 below the geometry to be bypassed 1111, until the poison level 1105 falls below the syphon bottom 1106. The gas in the syphon 1102 escapes via the gas escape line 1107 during activation, rather than through the syphon pipe 1103 (this prevents backpressure from gas being pushed below the coolant surface 1110). The device is shown in the state before activation in FIG. 11.

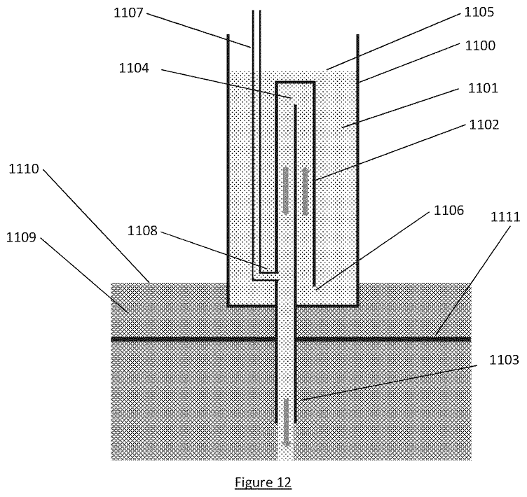

FIG. 12 shows the device of FIG. 11 during activation.

1. A nuclear fission reactor comprising a passive thermal shutdown device, and a reactor core containing fissile fuel, the passive thermal shutdown device comprising;
a reservoir, the reservoir being in thermal communication with the reactor core, and containing a neutron poison material which has a free surface;
a Pythagorean syphon having an inlet within the reservoir, an outlet in fluid communication with the reactor core ;
such that when the neutron poison material overtops the syphon due to thermal expansion, the neutron poison material flows through the Pythagorean syphon and into the reactor core.

2. A nuclear fission reactor according to claim 1, wherein the reactor further comprises a cooling system configured to cool the reactor core and comprising a coolant.

3. A nuclear fission reactor according to claim 2, wherein the reservoir is in thermal communication with the reactor core via a coolant flow exiting the reactor core and/or via gamma heating from nuclear reactions within the core.

4. A nuclear fission reactor according to claim and comprising a chamber within the reactor core and isolated from the coolant, wherein the outlet of the Pythagorean syphon is in fluid communication with the chamber such that when the neutron poison material overtops the syphon, the neutron poison material flows into the chamber.

5. A nuclear fission reactor according to claim wherein when the neutron poison material overtops the top edge of the syphon, the neutron poison material is released into the coolant, and wherein the neutron poison material is miscible with the coolant or soluble in the coolant.

6. A nuclear fission reactor according to claim 5, and comprising a pipe connecting the outlet of the syphon to a coolant inlet of the reactor core

7. A nuclear fission reactor according to claim 2, wherein the fissile fuel is the coolant.

8. A nuclear fission reactor according to claim 2, wherein the coolant is also a neutron moderator.

9. A nuclear fission reactor according to claim 1, wherein the reservoir comprises:
a tank containing the neutron poison material and the inlet of the Pythagorean syphon;
a sensing bulb filled with the neutron poison material and in thermal communication with the reactor;
a stem filled with the neutron poison material and connecting the sensing bulb to the main tank;
such that the thermal expansion of the neutron poison in the sensing bulb is sufficient for the neutron poison in the reservoir to overtop the syphon.

10. A nuclear fission reactor according to claim wherein the reservoir has a smaller cross section at the level at which fluid overtops the Pythagorean syphon than at a lower point in the reservoir.

11. A nuclear fission reactor according to claim 1, wherein the reservoir has an opening to a gas space, and comprises a bubbler airlock within the opening.

12. A nuclear fission reactor according to claim 1, wherein the neutron poison material is solid at an operating temperature of the reactor and liquid at a temperature at which it overtops the syphon material due to thermal expansion, and expands when melting.

13. A nuclear fission reactor comprising:
a passive thermal shutdown device,
a criticality safe dump tank, and
a reactor core containing a fully or partially liquid fissile fuel, which has a free surface
the passive thermal shutdown device comprising;
a Pythagorean syphon having inlet within the liquid fissile fuel, an outlet in fluid communication with the criticality safe dump tank;
such that when the fissile fuel overtops the Pythagorean syphon due to thermal expansion, the fissile fuel flows through the Pythagorean syphon and into the criticality safe dump tank.

14. A nuclear fission reactor according to claim 13, and where the fissile fuel is also the coolant.

15. A nuclear fission reactor according to claim 13, wherein the Pythagorean syphon is located outside of the critical region of the reactor core.

16. A nuclear fission reactor according to claim 13, wherein the reactor fuel space has a smaller cross section at the level at which fluid overtops the Pythagorean syphon than at a lower point in the reactor core.

17. A nuclear fission reactor comprising:
a passive thermal shutdown device, and a reactor core containing fissile fuel, the passive thermal shutdown device comprising;
a reservoir, the reservoir being in thermal and neutronic communication with the reactor core, and containing a liquid neutron moderator or reflector which has a free surface;
a Pythagorean syphon having an inlet within the reservoir, an outlet in fluid communication with a drain which leads to a location that is not in neutronic communication with the reactor core;
such that when the neutron moderator or reflector overtops the syphon due to thermal expansion, the neutron moderator or reflector flows through the Pythagorean syphon and into the drain.

18. A nuclear fission reactor according to claim 17, wherein the reactor further comprises a cooling system configured to cool the reactor core and comprising a coolant.

19. A nuclear fission reactor according to claim 18, wherein the reservoir is in thermal communication with the reactor core via a coolant flow exiting the reactor core and/or via gamma heating from nuclear reactions within the core.

20. A nuclear fission reactor according to claim 18, wherein the fissile fuel is also the coolant.

21. A nuclear fission reactor according to claim 18, wherein the cooling system comprises the reservoir and the neutron moderator or reflector is the coolant.

22. A nuclear fission reactor according to claim 17, wherein the reservoir comprises:
a tank containing the neutron moderator or reflector and the inlet of the Pythagorean syphon;
a sensing bulb filled with the neutron moderator or reflector and in thermal communication with the reactor;
a stem filled with the neutron moderator or reflector and connecting the sensing bulb to the main tank
such that the thermal expansion of the neutron moderator or reflector in the sensing bulb is sufficient for the neutron moderator or reflector in the reservoir to overtop the syphon.

23. A nuclear fission reactor according to claim 17, wherein the reservoir has a smaller cross section at the level at which fluid overtops the Pythagorean syphon than at a lower point in the reservoir.

24. A nuclear fission reactor according to claim 17, wherein the reservoir has an opening to a gas space, and comprises a bubbler airlock within the opening.

25. A nuclear fission reactor according to claim 17, wherein the neutron moderator or reflector is in a first phase at an operating temperature of the reactor and a second phase at a temperature at which he neutron moderator or reflector overtops the syphon material due to thermal expansion, and expands when changing phase between the first and second phase.
